(19) United States
(12) Patent Application Publication
(10) Pub. No.: US 2014/0006051 A1
(43) Pub. Date: Jan. 2, 2014

(54) EMERGENCY MEDICAL PROFILES

(71) Applicants: Victor Vuong, Kirkland, WA (US); Scott Hitch, Seattle, WA (US); Sean Nolan, Bellevue, WA (US); Benjamin C. Hamlin, Seattle, WA (US); Ivin T. Baker, Redmond, WA (US); Matthew E. Wagner, Redmond, WA (US); Takashi Moriyama, Redmond, WA (US); Zachary W. Little, Cupertino, CA (US); Paul K. Thackray, Seattle, WA (US)

(72) Inventors: Victor Vuong, Kirkland, WA (US); Scott Hitch, Seattle, WA (US); Sean Nolan, Bellevue, WA (US); Benjamin C. Hamlin, Seattle, WA (US); Ivin T. Baker, Redmond, WA (US); Matthew E. Wagner, Redmond, WA (US); Takashi Moriyama, Redmond, WA (US); Zachary W. Little, Cupertino, CA (US); Paul K. Thackray, Seattle, WA (US)

(73) Assignee: Microsoft Corporation, Redmond, WA (US)

(21) Appl. No.: 13/533,996

(22) Filed: Jun. 27, 2012

(51) Int. Cl. G06Q 50/24

(52) U.S. Cl. 705/3

(57) ABSTRACT

The description relates to emergency medical profiles and techniques for creating and accessing emergency medical profiles. One implementation can receive an access request to obtain emergency medical information from a personal health account of a patient. The personal health account can contain dynamically updateable patient information that is organized into a set of categories. This implementation can also provide the emergency medical information responsive to the request. In this case, the emergency medical information can be provided in the form of summarized information from a sub-set of the categories of the patient information contained in the personal health account.

### BACKGROUND

In the medical setting the amount of information associated with an individual patient is growing very rapidly. However, the large amount of data can itself create difficulties in quickly and easily accessing relevant portions of the information. This issue is especially prominent in emergency scenarios where a caregiver's quick access to relevant emergency medical information can be a matter of life and death.

### SUMMARY

This patent relates to emergency medical profiles and techniques for creating and accessing emergency medical profiles. One implementation can receive an access request to obtain emergency medical information from a personal health account of a patient. The personal health account can contain dynamically updateable patient information that is organized into a set of categories. This implementation can also provide the emergency medical information responsive to the request. In this case, the emergency medical information can be provided in the form of summarized information in an emergency medical profile. The summarized information can be obtained from a sub-set of the categories of the patient information contained in the personal health account.

Another implementation can receive an access request to obtain emergency medical information associated with a personal health account. The personal health account can contain dynamically updateable patient information that is organized into a set of categories. This implementation can communicate the access request to a service associated with the personal health account and obtain the emergency medical information associated with the personal health account. This implementation can present the emergency medical information as an emergency medical profile that is organized based upon individual categories.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-7 show examples of scenarios for implementing emergency medical profiles in accordance with some implementations of the present concepts.

FIG. 8 is an example of a system which can support emergency medical profiles in accordance with some implementations of the present concepts.

FIGS. 9-11 illustrate examples of flowcharts of emergency medical profile methods in accordance with some implementations of the present concepts.

### DETAILED DESCRIPTION

### Overview

This patent relates to safeguarding user (e.g., patient) health by making accurate timely emergency medical information available to caregivers in an emergency situation. More specifically, some implementations can leverage the patient's personal health account to generate an emergency medical profile for the patient. The personal health account can organize patient data submitted to the patient health account, such as by the medical professionals and/or the patient, among others. In one case, the submitted patient data is organized by category. For example, the data may be organized into categories such as medications, allergies, conditions, etc. Individual categories, such as conditions, can be selected for inclusion into the emergency medical profile. Further, individual categories can be filtered so that more relevant data from within the category is included in the emergency medical profile. For example, the category “conditions” can be filtered so that only current conditions are included on the emergency medical profile. Thus, the emergency medical profile can be automatically populated with data from relevant categories within the personal health account.

The present implementations can offer various mechanisms or venues through which the patient can make the emergency medical profile available to people who may act as caregivers in an emergency situation. For instance, in some cases the patient can create access codes for accessing the emergency medical profile. The patient can maintain control over the access codes and can cancel individual access codes and/or create new access codes as he/she desires.

### Scenario Examples

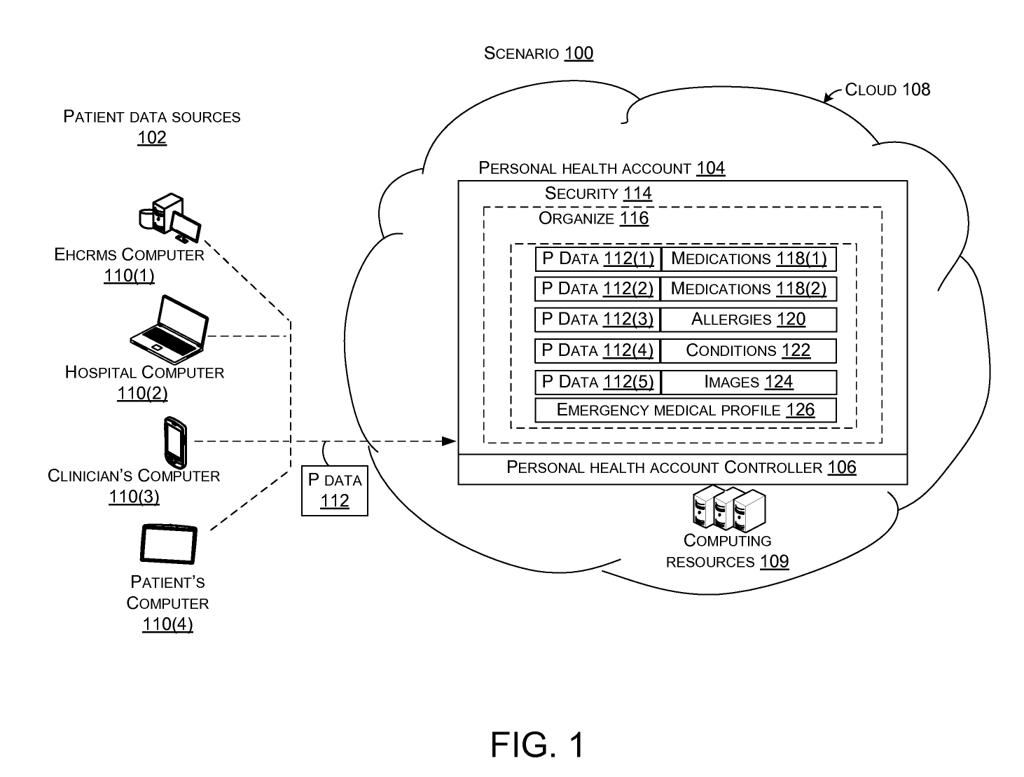

The discussion above broadly introduces some of the emergency medical profile concepts. To aid the reader in understanding these concepts, FIG. 1 illustrates system or scenario 100 that provides a tangible example to which the emergency medical profile concepts can be applied.

Example scenario 100 includes several patient data sources 102, a patient's personal health account 104, and accompanying personal health account controller 106. In this example, the personal health account 104 and accompanying personal health account controller 106 are implemented in the Cloud 108, but such need not be the case. The Cloud can include computing resources (e.g., computers) 109 which support the personal health account 104 and the personal health account controller 106. Also in this example, the patient data sources 102 includes multiple computers 110. Specifically, for purposes of example, the computers are manifest as an electronic health care records management service (EHCRMS) computer 110(1), a hospital computer 110(2), a clinician's computer 110(3), and a patient's computer 110(4). Of course, other numbers and types of computers can be utilized to supply patient data to the personal health account 104. Also, the descriptors given to the individual computers (e.g., hospital computer, patient computer, etc.) are provided for purposes of explanation and are not intended to limit individual computers to a specific user scenario.

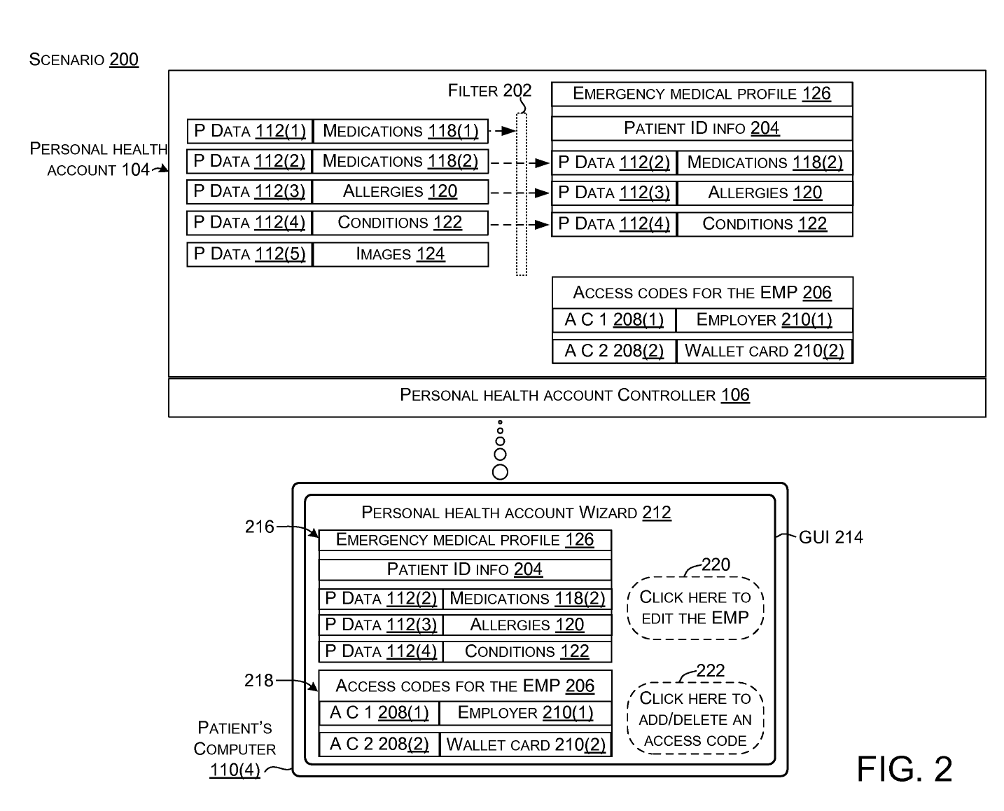

Patient data 112 can be sent from any of computers 110(1)-110(4) to the patient's personal health account 104 via the personal health account controller 106. The personal health account controller can oversee various functions relating to the patient data 112. For example, among other functions, the personal health account controller 106 can secure the patient data in the personal health account as indicated by security 114. The personal health account controller can also organize the patient data as indicated at 116. For instance, the personal health account controller can organize the patient data into categories. In this example, portions of the patient data designated as 112(1) and 112(2) are categorized as “medications” as indicated at 118(1) and 118(2). Similarly, patient data 112(3) is categorized as “allergies” 120, patient data 112(4) is categorized as conditions 122 and patient data 112(5) is categorized as “images” 124. Of course space on the drawing page limits the number of examples of patient data, but often a patient's personal health account may include hundreds or thousands of categorized data portions. Further, more and/or different categories may be utilized than can be illustrated and discussed here. Personal health account 104 can further include an emergency medical profile 126 for the patient that can leverage the categorized patient data 112(1)-112(4). This aspect will be discussed in more detail below relative to FIG. 2.

FIG. 2 shows another scenario 200 that provides additional details regarding the emergency medical profile 126. In this example, the emergency medical profile can be automatically populated with select patient data from the personal health account 104. For instance, for a set of categories used to classify patient data in the personal health account, a sub-set of the categories may be deemed as relevant for inclusion in the emergency medical profile. In some implementations, the decision regarding what categories to include in the emergency medical profile can be made in advance, such as by a panel of experts. In this example, the “medications”, “allergies” and “conditions” categories are included in the emergency medical profile 126 and the “images” category is not.

Some implementations can also include a filter(s) 202 that further limits what patient data from the personal health account 104 is included in the emergency medical profile 126. For example, in this case, the filter 202 can exclude older patient data so that only current patient data is included. For instance, assume that patient data 112(1) is for medication 118(1) that the patient is no longer taking (e.g., an expired prescription). Conversely, assume that patient data 112(2) is for medication 118(2) that the patient is currently taking (e.g., a current prescription). Accordingly, while the category “medications” is included in the emergency medical profile, patient data 112(1) is excluded by filter 202 (e.g., not included in emergency medical profile 126).

The emergency medical profile 126 can also include a patient ID info region 204. The patient ID info region can be automatically populated with patient bibliographic data, such as patient's name, patient ID, and/or patient's date of birth, among others. In some cases, the patient bibliographic data is supplied during set-up of the personal health account and does not need to be re-entered.

As introduced above, access to the emergency medical profile 126 can be controlled by access codes. In this example, access codes for the emergency medical profile (EMP) are listed generally at 206. A first access code (access code 1) is indicated at 208(1) and a second access code is listed at 208(2). As indicated at 210(1), the user (e.g., the patient) has assigned access code 1 to his/her employer and the patient has assigned access code 2 to a wallet card as indicated at 210(2). The purpose of the access codes will be described in more detail below after all of the elements of FIG. 2 are introduced.

The personal health account controller 106 can also support a personal health account wizard 212. The personal health account wizard can operate in the Cloud or on the patient's computer 110(4), among others. The personal health account wizard 212 can allow the user to set up and/or edit his/her personal health account and/or the associated access codes. In this example, the personal health account wizard can generate a graphical user interface (GUI) 214 that can be viewed on the patient's computer 110(4). As indicated at 216, the GUI can recreate a view of the emergency medical profile. Similarly, as indicated at 218, the GUI can recreate a view of the access codes. Further, the personal health account wizard can allow the user to select to edit the emergency medical profile as indicated at 220 or the access codes at 222.

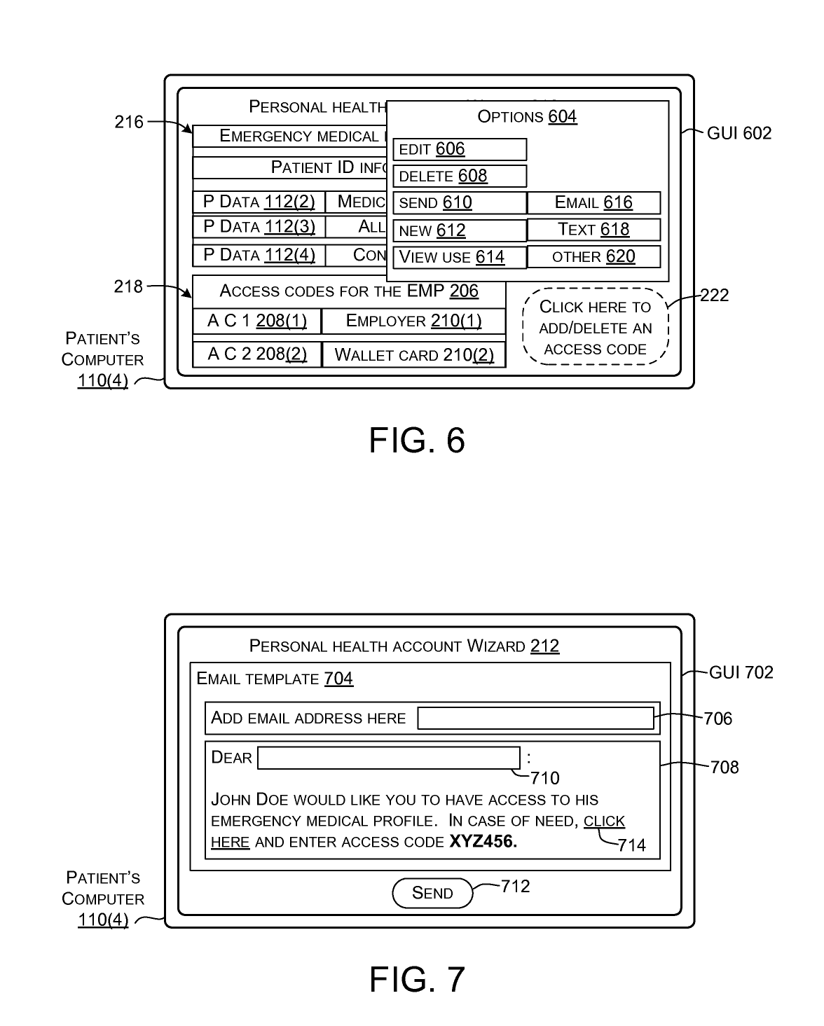

In some cases, the patient may want to set up an emergency medical profile as soon as he/she establishes the personal health account 104. In such a case, the personal health account may contain little or no patient data. In this example, the patient could use the “edit the EMP” feature 220 to manually add patient data to the emergency medical profile. This information can then be supplanted as the patient's medical records are added to the personal health account. Some implementations may also allow the patient to determine and/or adjust which categories are included on the emergency medical profile. In still other implementations, the content of the emergency medical profile can be automatically populated and then the user can be given the option to hide and/or add information as desired. The “add/delete an access code” feature will be described below relative to FIGS. 6-7.

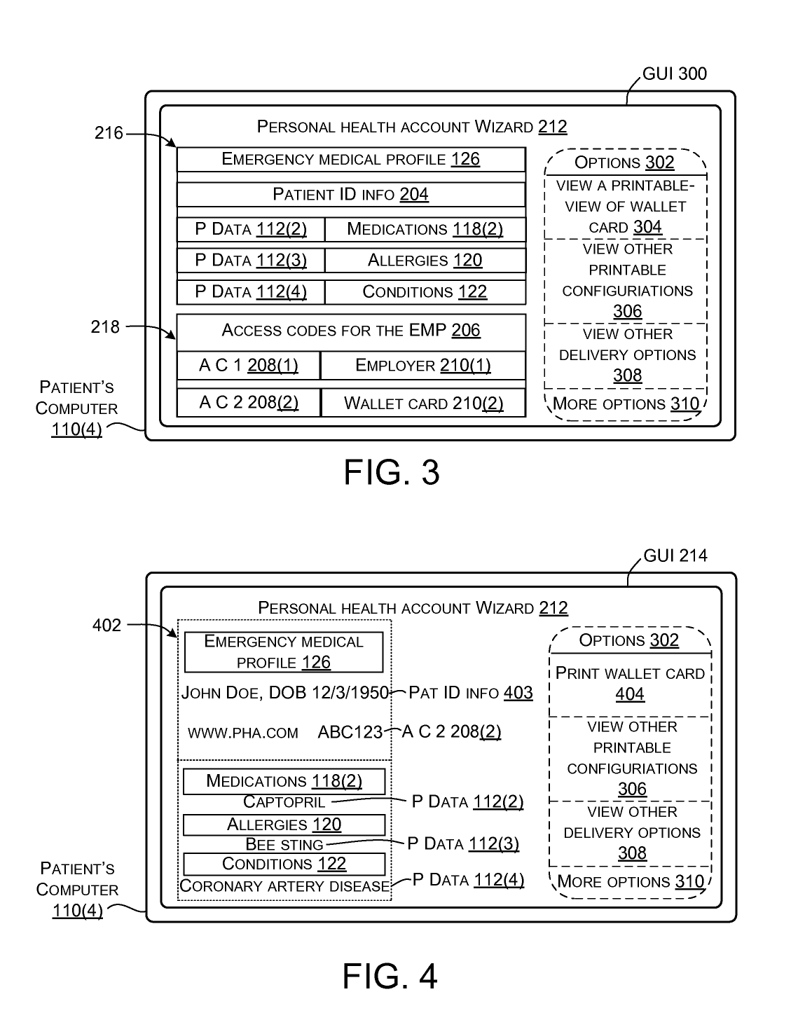

FIGS. 3-4 show examples of two more personal health account wizard GUIs that build upon GUI 214 of FIG. 2. Many of the elements of FIGS. 1-2 are retained in FIGS. 3-4 and are not re-introduced here for sake of brevity.

FIG. 3 shows a GUI 300 that relates to a personal health account wizard 212. GUI 300 introduces a wizard options feature as indicated at 302. The wizard options feature can offer a list of frequently used options to the user that relate to the emergency medical profile 126. In this case, the illustrated options are “view a printable version of the wallet card” at 304, “view other printable configurations” at 306, “view other delivery options” at 308 and “more options” at 310. If the patient wants options other than the listed options 304, 306, or 308, selecting more options 310 can cause an expanded set of options to be presented or otherwise allow the user to control other aspects related to his/her emergency medical profile. Assume for purposes of explanation that the patient selects the “view a printable version of the wallet card” option 304.

FIG. 4 shows a subsequent GUI 400 that includes a printable view 402 of the wallet card of the emergency medical profile 126. Further, to provide a more realistic illustration, examples of patient data and other fields are illustrated in the printable view 402 of the wallet card. For example, Patient ID info is listed as “John Doe, DOB Dec. 3, 1950” at 403. The access code 2 208(2) is listed as “ABC123” and is shown with a URL of a hypothetical web address “www.pha.com” for accessing an electronic version of the emergency medical profile 126.

The patient data 112(2) under medications 118(2) is listed as “Captopril”. Patient data 112(3) under allergies 120 is listed as “bee stings” and patient data 112(4) under conditions 122 is listed as “coronary artery disease”. Assume for purposes of explanation that the patient prints the wallet card by clicking “print wallet card” 404.

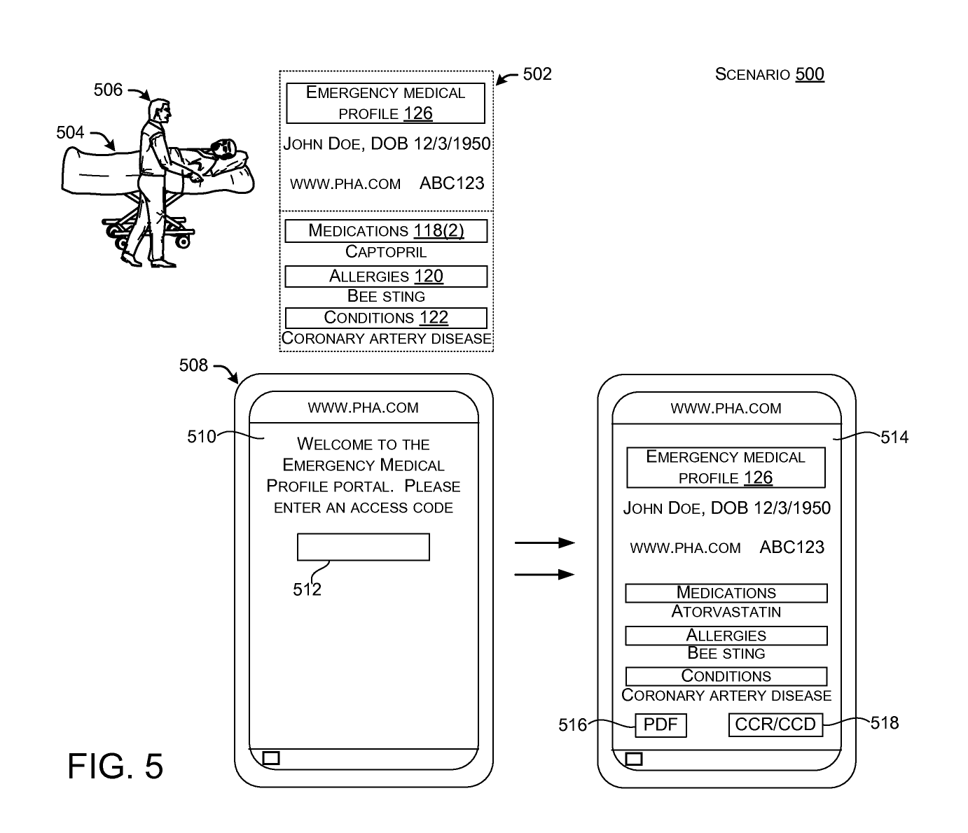

FIG. 5 shows a scenario 500 relating to use of an emergency medical profile wallet card 502 introduced above in the discussion relative to FIG. 4. In this case, assume that the patient 504 printed the wallet card 502 and kept it with him. Assume further that the patient has experienced a health issue, such as chest pains. The patient can give the wallet card to caregiver 506, such as a paramedic or emergency care provider. If the patient is unconscious the caregiver can find the wallet card in the patient's wallet when trying to ascertain the patient's identity. In either case, the wallet card can immediately provide the caregiver with useful information for treating the patient.

In some instances, because of the static nature of the physical wallet card 502 the information on the wallet card may be outdated. However, in this implementation the wallet card's access code can allow the caregiver to view a current version of the patient's emergency medical profile 126 to verify the information. For example, in this case the caregiver 506 can enter the URL “www.pha.com” (this is a hypothetical URL) from the wallet card on his smart phone 508 (or other computer). In this case, this URL is associated with the personal health account controller (FIG. 1). The personal health account controller can generate a first GUI 510 on the caregiver's smart phone 508. The first GUI can ask the caregiver to enter an access code at 512. Assume that the caregiver enters the access code “ABC123” from the wallet card 502 into first GUI 510. A second GUI 514 can be generated on the caregiver's smart phone responsive to receiving the access code.

In this case the second GUI 514, shows a current version of the emergency medical profile 126, which may include changes from the emergency medical profile 126 on the wallet card 502. Note, for purposes of example, that the medication “Captopril” listed on the wallet card 502 is not listed on the current emergency medical profile shown on second GUI 514. Instead, the listed medication is “Atorvastatin”. Such a result could occur where in the interim time period between printing of the wallet card and the medical incident, the Captopril prescription expired or was discontinued and the patient was given a new prescription for Atorvastatin. Thus, the present implementations can offer both a physical version of the patient's relevant medical information in the form of the wallet card and the wallet card can also supply a way to access current patient information via the access code on the wallet card.

The current emergency medical profile shown on second GUI 514 also offers the option of exporting the emergency medical profile. In this example, the caregiver is offered the option of exporting the current emergency medical profile as a “PDF” (portable document format) document at 516 or as “CCR/CCD” (continuity of care record/continuity of care document) at 518. CCR and CCD are standards for transferring a patient's medical information electronically. The CCR/CCD option is configured to export the information from the emergency medical profile in this form so that the information is readily available via a caregiver's infrastructure (when supported). For example, this feature can allow the information from the emergency medical profile to automatically be uploaded into, and be recognized by, an electronic medical records management service at the institution where the caregiver works. The information can then be viewed by the caregiver (and/or other caregivers) through GUIs generated by the electronic medical records management service.

Note that while in this example, the access code “ABC123” and a corresponding URI “www.pha.com” for entering the access are shown on the wallet card 502, this is just one possible implementation. For instance, in another implementation, the access code and the URI can be conveyed via a bar code. Many types of bar codes can be suitably used for conveying such information. One type of bar code that is currently in widespread use is the QR code, but others could alternatively be used. Such bar codes can be faster and/or more convenient for the caregiver. For instance, by including a QR code on the wallet card 502, the caregiver could simply take a picture of the CR code with smartphone 508 to see the electronic (and up-to-date) version of the wallet card.

In the above example, the patient was carrying a “stale” printed wallet card (e.g., the wallet card contained outdated information). Note that some implementations can provide a notification to the user to print a new wallet card any time changes occur to the information of the patient's emergency medical profile. For instance, an email or a text could be sent to the patient to remind them to print a new wallet card. The notification can alternatively or additionally be presented to the patient when accessing his personal health account via a pop-up window or the like. Note also, that similar notification techniques can be utilized to notify the patient when an individual access code is used to access the patient's emergency medical profile. This notification can allow the user to take further action if so desired. For instance, if the access was unauthorized, such as if the patient's wallet was stolen, the user could inactivate the access code to prevent further use. The user could then create a new wallet card with a new access code.

FIGS. 6-7 collectively build upon another aspect introduced in FIG. 2. Some elements are retained from FIG. 2 and are not re-introduced here. FIG. 6 shows a GUI 602 of the patient's computer 110(4) that builds upon GUI 214 of FIG. 2. This aspect relates to sending an access code to an entity, such as a person or organization. In this example, assume that the patient wants to send access code 1 208(1) to his employer 210(1). Assume further that the patient tapped on, or otherwise activated, the “employer 210(1)” portion of that touchscreen and that an options display 604 was generated responsive to the user action. For purposes of explanation, the options display includes an “edit” option 606, a “delete” option 608, a “send” option 610, a “new” option 612, and a “view use” option 614.

Assume that the patient selected the send option 610 and that an “email” option 616, a “text” option 618 and an “other” option 620 were presented responsive to the user selection. In this case, assume that the patient wants to send an email notification that includes the access code and accordingly selects email 616.

FIG. 7 shows another GUI 702 on patient's computer 110(4) generated responsive to the patient actions described above relative to FIG. 6. In this case, the personal health account wizard 212 can provide an email template 704. The email template can allow the patient to enter an email address of the recipient at 706. The email template can also be populated with text for the email message as indicated at 708 and can be automatically populated with information from the patient's personal health account where feasible. The patient can add the recipient at 710 and can edit the message if desired. The patient can send the email once the patient is satisfied with the content and has entered the email address as indicated at 712.

The email message can include a URL or a link to a URL 714 to a web-site for accessing the emergency medical profile. Entering the access code “XYZ456” at the web-site can allow the recipient to access the patient's emergency medical profile in a manner similar to that explained relative to first and second GUIs 510 and 514, respectively of FIG. 5.

Returning to FIG. 6, in an alternative scenario, the patient may switch employers and therefore want to inactivate the access code that he emailed to his previous employer. In this scenario, the patient can utilize the delete option 608 or the click here to add/delete an access code 222. The patient can then cause the creation of a new access code and message for the new employer. Further, the patient can utilize the “view use” option 614 to see whether (and when) the previous employer used the access code (e.g., was access code “XYZ123” ever used and if so, when).

### System Examples

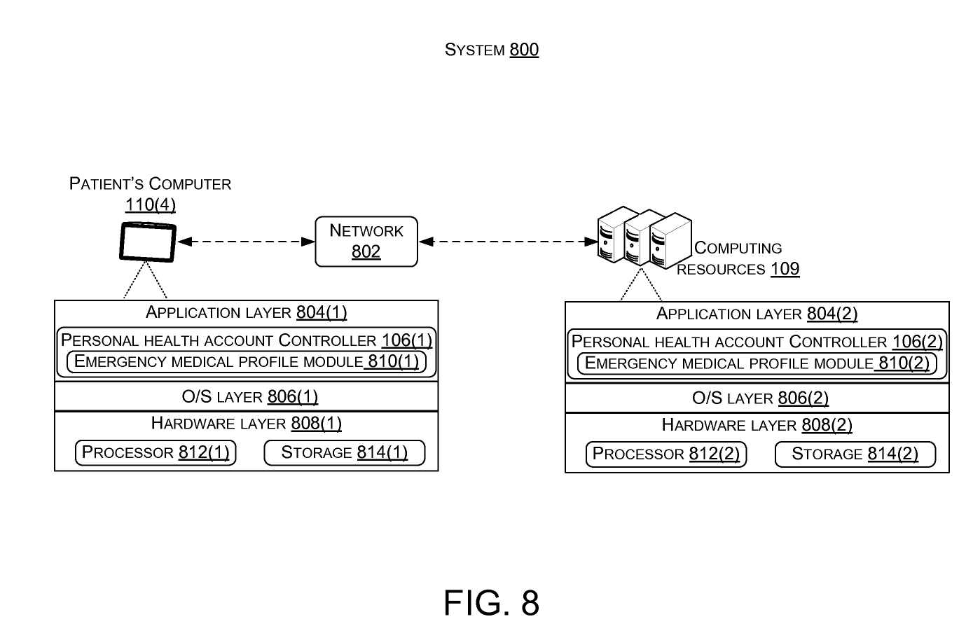

FIG. 8 shows a system 800 in which emergency medical profile concepts can be implemented. In this case, scenario 100 includes patient computer 110(4) and computing resources 109 from FIG. 1. While not shown for sake of brevity the discussion below can relate to other computers, such as computer 110(1)-110(3) of FIG. 1, other user computers, and/or other server computers that are not cloud based, among others. In this configuration, the computers can communicate with each other and/or with computing resources 109 via a network 802.

For purposes of explanation computer 110(4) and computing resources 109 can include several elements which are defined below. For example, patient's computer 110(4) and computing resources 109 can include an application layer 804 that operates upon an operating system layer 806 that operates upon a hardware layer 808. (In this case, the suffix “(1)” is used to indicate an instance of these elements on computer 110(4), while the suffix “(2)” is used to indicate an instance on computing resources 109. The use of these elements without a suffix is intended to be generic).

The application layer 804 can include personal health account controller 106. The personal health account controller can include an emergency medical profile module 810. The hardware layer 808 can include a processor 812 and storage 814, as well as additional hardware components, such as input/output devices, buses, graphics cards, etc., which are not illustrated or discussed here for sake of brevity.

In one implementation, the personal health account controller 106(1) can be configured to receive an access request to obtain emergency medical information from a personal health account of a patient. The emergency medical profile module 810 can be configured to provide the emergency medical information. Examples illustrating such scenarios are described above relative to FIGS. 1-7.

In one implementation, both computer 110(4) and computing resources 109 can be configured to accomplish the emergency medical profile concepts described above and below. For example, computer 110(4) can have a robust personal health account controller 106(1) and a robust emergency medical profile module 810(1), such that computer 110(4), operating in isolation, can accomplish the emergency medical profile concepts. Similarly, the computing resources 109 can have a robust personal health account controller 106(2) and a robust emergency medical profile module 810(2), such that the personal health account controller, operating in isolation, can accomplish the emergency medical profile concepts described above and below.

In other implementations, the computing resources 109 can have a robust personal health account controller 106(2) and a robust emergency medical profile module 810(2), while computer 110(4) may include a personal health account controller 106(1) and/or emergency medical profile module 810(1) that offer more limited functionality for accomplishing the described concepts in cooperation with the cloud resources. In one such case, the personal health account controller 106(1) and/or emergency medical profile module 810(1) on computer 110(4) can be a downloadable application that can allow the patient to interact with the personal health account controller 106(2) and/or emergency medical profile module 810(2) on the computer resources 109 which perform a majority of the data storage and processing. For example, the patient's computer can generate GUIs into which the patient inputs data relating to his personal health account. However, the personal health account can be generated on the computing resources 109 for display on a subsequent GUI on patient's computer 110(4).

The term “computer” or “computing device” as used herein can mean any type of device that has some amount of processing capability and/or storage capability. Processing capability can be provided by one or more processors (such as processor 812) that can execute data in the form of computer-readable instructions to provide a functionality. Data, such as computer-readable instructions, can be stored on storage, such as storage 814 that can be internal or external to the computer. The storage can include any one or more of volatile or non-volatile memory, hard drives, flash storage devices, and/or optical storage devices (e.g., CDs, DVDs etc.), among others. As used herein, the term “computer-readable media” can include transitory and non-transitory computer-readable instructions. In contrast, the term “computer-readable storage media” excludes transitory instances and signals. Computer-readable storage media includes “computer-readable storage devices”. Examples of computer-readable storage devices include volatile storage media, such as RAM, and non-volatile storage media, such as hard drives, optical discs, and flash memory, among others.

In the illustrated implementation patient's computer 110(4) and computing resources 109 are configured with a general purpose processor 812 and storage 814. In some configurations, a computer can include a system on a chip (SOC) type design. In such a case, functionality provided by the computer can be integrated on a single SOC or multiple coupled SOCs. In one such example, the computer can include shared resources and dedicated resources. An interface(s) can facilitate communication between the shared resources and the dedicated resources. As the name implies, dedicated resources can be thought of as including individual portions that are dedicated to achieving specific functionalities. For instance, in this example, the dedicated resources can include the personal health account controller 106.

Shared resources can be storage, processing units, etc. that can be used by multiple functionalities. In this example, the shared resources can include the processor. In one case, as mentioned above personal health account controller 106 can be implemented as dedicated resources. In other configurations, this component can be implemented on the shared resources and/or the processor can be implemented on the dedicated resources. In some configurations, the personal health account controller 106 can be installed during manufacture of the computer or by an intermediary that prepares the computer for sale to the end user. In other instances, the end user may install the personal health account controller 106, such as in the form of a downloadable application.

Examples of computing devices can include traditional computing devices, such as personal computers, cell phones, smart phones, personal digital assistants, or any of a myriad of ever-evolving or yet to be developed types of computing devices. Further, aspects of system 800 can be manifest on a single computing device or distributed over multiple computing devices.

### First Method Example

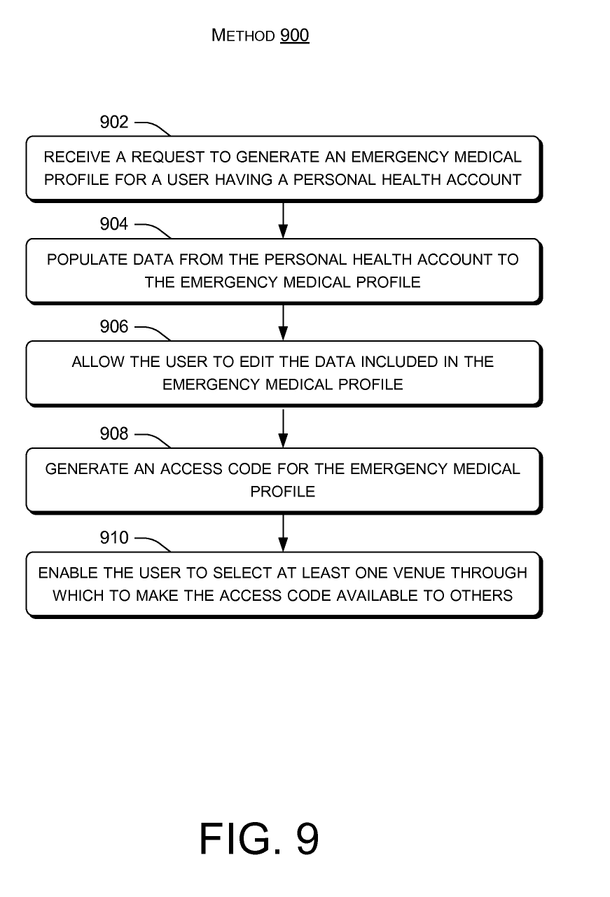

FIG. 9 illustrates a flowchart of a method or technique 900 that is consistent with at least some implementations of the present concepts.

In this case the method can receive a request to generate an emergency medical profile for a user having a personal health account at 902.

The method can populate data from the personal health account to the emergency medical profile at 904. In some cases, the personal health account contains dynamically updateable patient information that is organized into a set of categories. In such cases, populating the data can entail identifying a sub-set of the categories to include in the emergency medical profile. The data can then be filtered from the sub-set of categories for inclusion in the emergency medical profile.

The method can allow the user to edit the data included in the emergency medical profile at 906. This feature can allow the user to customize his/her profile in a manner that they find suitable to their needs.

The method can generate an access code for the emergency medical profile at 908. Access codes can be anything that conveys a unique identification. Access codes with varying levels of security can be utilized. In many implementations, the access codes are manifest as a number of user recognizable characters. Cryptographically secure access codes may utilize 20 or more characters. Further, some characters may not be utilized to avoid mis-identification by a caregiver in an emergency situation. For instance, some implementations may not utilize the letters “i”, “I”, “l”, or “L” since a capital I may be mistaken for a small l and vice versa.

The method can enable the user to select at least one venue through which to make the access code available to others at 910. In some cases, the “others” can be thought of as the intended recipient, such as an employer, daycare, friends, etc. In the case of an wallet card, the intended recipient may not be readily apparent in advance since the wallet card may never be used unless the patient has some type of medical incident, such as an accident. Thus, the user may associate an individual access code to a specific intended recipient or entity, where in other cases the user may not make such an association or the association may be made between an individual access code and the wallet card for which it is intended.

The venue can include email, social web-sites, and physical printouts, among others. Further, some implementations can offer various physical printout options. For example, one physical printout option could be a single page wallet card (e.g., credit card size) that is printed on one side or both sides. Another option could be a foldable wallet card. For instance, a single fold can double the effective area of the card and a bi-fold card can have triple the printable area, etc. To summarize, in some implementations, an emergency medical profile intended for one venue may include more patient data than an emergency medical profile intended for another venue.

The amount of patient data appearing on a particular instance of the emergency medical profile can be adjusted to be accommodated on an individual physical printout option. For example, the filter described above relative to FIG. 2 can achieve such adjustment by adjusting parameter values utilized in the filtering process. For example, the emergency medical profile for a single page wallet card in relation to the medications category may list “Captopril”. In contrast, the emergency medical profile for a double page foldable wallet card may list “Captopril” and “dose 100 mg/twice daily”. Further, while wallet card configurations are discussed here, other configurations may allow the user to print larger emergency medical profiles, such as standard printer paper sizes such as 8.5×11 or A4. Such configurations can allow further details to be included on the printed emergency medical profiles.

In summary, some implementations can allow the user to create multiple access codes for different recipients. The user can then define a version of the patient data to be included in the individual emergency medical profiles associated with the individual access codes and hence the individual recipients.

### Second Method Example

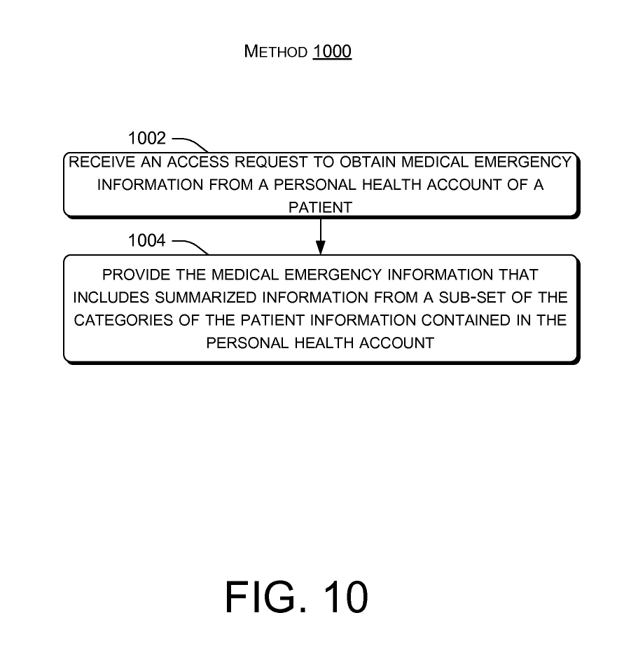

FIG. 10 illustrates a flowchart of a method or technique 1000 that is consistent with at least some implementations of the present concepts.

In this case the method can receive an access request to obtain emergency medical information from a personal health account of a patient at 1002. The personal health account can contain dynamically updateable patient information that is organized into a set of categories.

The method can provide the emergency medical information that includes summarized information from a sub-set of the categories of the patient information contained in the personal health account at 1004.

In one implementation the providing can include validating the access request. For instance, the validating can be accomplished by comparing the received access request to a listing of current access codes. The providing can also include identifying the sub-set of the categories of the set for inclusion in the emergency medical information. Individual filters can be applied to individual categories of the sub-set to determine which patient data to consider. Summarized information can then be derived from the individual categories that satisfy the respective individual filters.

### Third Method Example

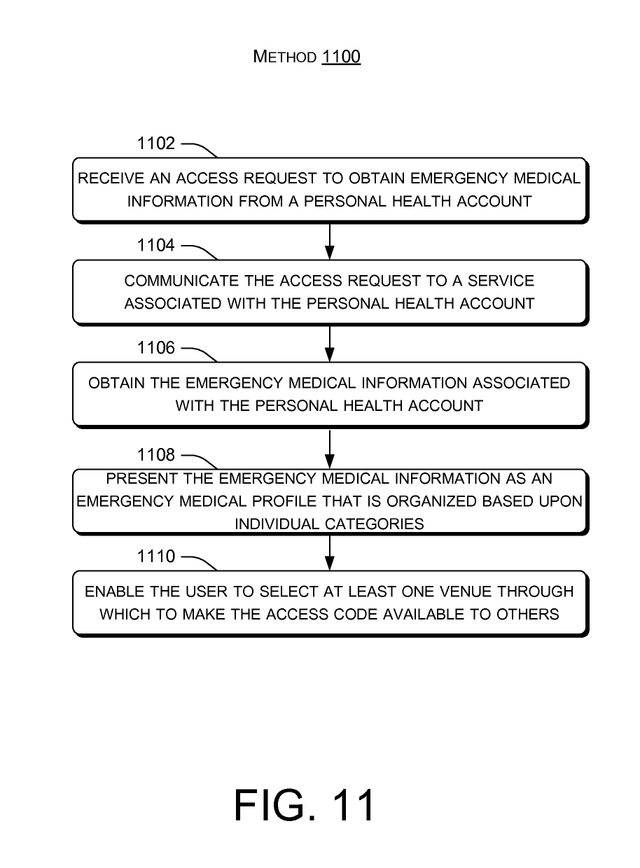

FIG. 11 illustrates a flowchart of a method or technique 1100 that is consistent with at least some implementations of the present concepts.

In this case the method can receive an access request to obtain emergency medical information from a personal health account at 1102. For example, the access request can be manifest as a bar code that includes a uniform resource locator (URL) of the service and an access code issued by the service The personal health account can contain dynamically updateable patient information that is organized into a set of categories.

The method can communicate the access request to the service associated with the personal health account at 1104.

The method can obtain the emergency medical information associated with the personal health account at 1106. In one example, the obtaining can include receiving the information or accessing the information on a web-site associated with the service.

The method can present the emergency medical information as an emergency medical profile that is organized based upon individual categories at 1108. The presenting can be manifest as visually displaying the emergency medical profile on a computer display. An amount of information displayed can be dependent upon a display area of the computer display. For visually impaired users, the presenting can be manifest as an audio presentation of the emergency medical profile.

The method can enable the user to select at least one venue through which to make the access code available to others at 1110. In some implementations, the emergency medical profile configuration may be linked to the selected venue. For example, an emergency medical profile intended for a wallet card may include less content than an emergency medical profile intended for a full page printout. Further, the device on which the emergency medical profile is displayed may affect the content. For example, smartphones tend to have less display area than desktop, notebook, or pad type computers. Accordingly, an emergency medical profile displayed on a smartphone may have an abridged version of the content displayed on a larger display device.

The order in which the example methods are described is not intended to be construed as a limitation, and any number of the described blocks or acts can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although techniques, methods, devices, systems, etc., pertaining to emergency medical profiles are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
receiving a request to generate an emergency medical profile for a user having a personal health account;
populating data from the personal health account to the emergency medical profile;
allowing the user to edit the data included in the emergency medical profile;
generating an access code for the emergency medical profile; and,
enabling the user to select at least one venue through which to make the access code available to others.

2. The method of claim 1, wherein the personal health account contains dynamically updateable patient information that is organized into a set of categories and wherein the populating comprises:
identifying a sub-set of the categories to include in the emergency medical profile; and,
filtering the data from the sub-set of the categories for inclusion in the emergency medical profile.

3. The method of claim 1, wherein the others comprise an intended recipient and further comprising allowing the user to associate the access code with the intended recipient.

4. The method of claim 1, wherein the at least one venue includes email, social web-sites, or physical printouts.

5. The method of claim 4, wherein the physical printouts involve at least first and second printouts, and wherein the first printout includes more area of printable space that the second printout.

6. The method of claim 5, wherein the populating data from the personal health account to the emergency medical profile includes populating more of the data for a first individual venue than a second individual venue.

7. The method of claim 5, wherein the populating data from the personal health account to the emergency medical profile includes more of the data for the first printout than the second printout.

8. The method of claim 1, further comprising generating another access code and allowing the user to define a version of the data in the emergency medical profile accessible with the access code and to define a different version of the data in the emergency medical profile accessible with the another access code.

9. At least one computer-readable storage medium having instructions stored thereon that, when executed by a processor, cause the processor to perform acts, comprising:
receiving an access request to obtain emergency medical information from a personal health account of a patient, the personal health account containing dynamically updateable patient information that is organized into a set of categories; and,
providing the emergency medical information comprising summarized information from a sub-set of the categories of the patient information contained in the personal health account.

10. The computer-readable storage medium of claim 9, wherein the providing comprises:
validating the access request;
identifying the sub-set of the categories of the set for inclusion in the emergency medical information;
applying individual filters to individual categories of the sub-set; and,
deriving the summarized information from the individual categories that satisfy the respective individual filters.

11. The computer-readable storage medium of claim 9, wherein the computer-readable storage medium comprises a computer-readable storage device, and wherein the computer-readable storage device and the processor are embodied on a single computer.

12. The computer-readable storage medium of claim 11, wherein the computer includes a personal health account controller configured to perform the receiving and an emergency medical profile module configured to perform the providing.

13. A method, comprising:
receiving an access request to obtain emergency medical information associated with a personal health account, the personal health account containing dynamically updateable patient information that is organized into a set of categories;
communicating the access request to a service associated with the personal health account;
obtaining the emergency medical information associated with the personal health account; and,
presenting the emergency medical information as an emergency medical profile that is organized based upon individual categories.

14. The method of claim 13, wherein the receiving an access request comprises receiving a bar code that includes a uniform resource locator (URL) of the service and an access code issued by the service.

15. The method of claim 13, wherein the obtaining comprises receiving the emergency medical information or accessing the emergency medical information on a web-site associated with the service.

16. The method of claim 13, wherein the presenting comprises visually displaying the emergency medical profile on a computer display.

17. The method of claim 16, wherein an amount of information populated in the emergency medical profile is dependent upon a display area of the computer display.

18. The method of claim 16, stored as instructions on at least one computer-readable storage medium, the instructions when executed by a processor, cause the processor to perform the method and wherein the computer-readable storage medium and the processor are manifest on a server computer that performs the receiving, the communicating, the obtaining, and the presenting.

19. The computer-readable storage medium of claim 18, wherein the server computer is a cloud-based server computer.

20. The method of claim 13, stored as instructions on at least one computer-readable storage medium, the instructions when executed by a processor, cause the processor to perform the method and wherein the computer-readable storage medium and the processor are manifest on a smartphone that performs the receiving, the communicating, the obtaining, and the presenting.
